(19) United States
(12) Patent Application Publication
(10) Pub. No.: US 2024/0059126 A1
(43) Pub. Date: Feb. 22, 2024

(54) SELF-DEFROSTING CARGO TRANSPORT CONTAINER OR TRAILER

(71) Applicant: Cornell Tyler, Chicago, IL (US)

(72) Inventor: Cornell Tyler, Chicago, IL (US)

(21) Appl. No.: 18/235,800

(22) Filed: Aug. 18, 2023

Related U.S. Application Data
(60) Provisional application No. 63/399,490, filed on Aug. 19, 2022.

(51) Int. Cl. B60H 1/22; B60S 1/66

(52) U.S. Cl. CPC B60H 1/2227; B60S 1/66

(57) ABSTRACT

The present invention is directed to a heating (defrosting) system configured to provide heat to a top surface of a for a vehicle, a transport container, or trailer (e.g., a tractor trailer). The heating (defrosting) system may comprise at least one power source (e.g., a battery), at least one ON/OFF power switch, at least one electrically conductive cable or wire configured to defrost or heat at least one external surface of the vehicle, transport container, or trailer that may otherwise be susceptible to frost, ice, and/or snow accumulation, and at least multi-plug electric power connector configured to accept at least one electrically conductive cable or wire and to distribute electric current throughout the at least one electrically conductive cable or wire. If desired, the heating (defrosting) system may further include at least one thermostat and at least one temperature sensor to activate or deactivate the heating (defrosting) system at a selected temperature above freezing point. The heating (defrosting) system may also be provided with at least one optional ice sensor for activating or deactivating the heating (defrosting) system, as may be necessary. The at least one electrically conductive cable or wirer may be positioned either internally or externally. When positioned internally, the cable or wire may be placed along a top side of any support structures that may be present (e.g., the support rails in a trailer). When positioned externally, the cables or wires may be positioned on an external surface (e.g., the top side) of the vehicle, transport container, or trailer.

### RELATED APPLICATION

This application claims benefit of U.S. Provisional Application No. 63/399,490 files Aug. 19, 2022.

### FIELD OF THE INVENTION

The present invention relates generally to a cargo transport container, and more particularly, to a self-defrosting cargo transport container including a heating (defrosting) system designed to eliminate, reduce, or prevent frosting, icing, and/or snow accumulation on various transport containers, such as, vans, or transport containers used with tractor truck and semi-trucks.

### BACKGROUND OF THE INVENTION

It is well-established that accumulated snow and ice on transport containers or trailers, such as, tractor trailers containers can be a lethal hazard. For example, in 1999, a New Hampshire driver was tragically killed when a huge piece of ice slid from the top of a tractor trailer and smashed into the driver's vehicle. Since then, New Hampshire passed a law imposing fines against drivers who fail to clear their vehicles of ice and snow. Other states have enacted similar legislation.

Many drivers climb on top of their rigs, including tractor trailers, to inspect for and/or remove accumulated ice and snow. Not only is such an undertaking labor-intensive, it places the person performing the task at a substantial risk of injury and/or even death because the surface of the rig may be very slippery.

Various machines designed for truck and trailer ice and snow removal or deicing are currently available at truck stop facilities and service centers. However, ice and snowstorms can develop unexpectedly at any time wherever freezing conditions may occur. Therefore, these facilities provide only a limited solution for defrosting or deicing. The facilities are ineffective when the ice or snow occurs when the transport container is being used remote from the truck stop.

Additionally, defrosting systems have been proposed previously. Typical prior art defrosting systems include the automobile's windshield defrosting systems and the rear-window electric defroster found as standard safety features in all vehicles. Windshield defrosters blow air (e.g., air-conditioned air) onto the vehicle windshield through vents at the forward edge of the vehicle dashboard. By contrast, rear defrosters use a grid of electrically powered wires, visible as thin lines, to heat the rear window to defog the glass and melt ice, frost, and snow.

It is also known to provide a motor vehicle with a heat source coupled to a system of ducts arranged on the underside of the vehicle, the duct system having vents for providing a stream of hot air to melt ice and snow around the vicinity of the vehicle's underside, including near the tires. These systems have not been used for other areas of a vehicle, a transport container, or a trailer.

Additionally, powering transport refrigeration units (i.e., tractor trailers provided with refrigeration units), known as “reefers,” have been proposed for the purpose of transporting temperature sensitive cargo such as food. These units may be powered by a battery, which may be used in combination with an internal combustion engine generator and/or solar panels. Some of these systems may be equipped with ice detectors for use in defrosting the refrigeration inlets and outlets of an evaporator section.

For example, a system for refrigerating a reefer has previously been proposed in which a reefer container with a plurality of compartments comprises: an energy supply unit comprising a battery; a controller; a system of tubes configured to circulate refrigerant to and from the unit through the reefer and configured to place the refrigerant to be in thermal communication with the compartments; and a refrigerant for the thermal energy exchange. The battery can be charged either while connected to the engine of the cab and/or via an external power source before, during, or after a journey. Another prior reefer system uses, for its driving force, energy derived from an integrated combination of electrical power generated from an internal combustion engine generator, an electric grid, a wheel driven generator, and at least one solar panel. A further prior transportation refrigeration system can operate in a cooling mode, a defrost mode, and a heating mode to condition air in an air-conditioned space. In these systems, a refrigeration circuit fluidly connects a compressor, a condenser, a tank, and an evaporator, which is in thermal communication with the air-conditioned space. The system further comprises a heating circuit fluidly connecting the compressor, the tank, the evaporator, and a heater, as well as a defrost circuit fluidly connecting the compressor, the tank, the evaporator, and the heater.

None of the aforementioned refrigeration units have been used to eliminate, reduce, or prevent freezing, frosting, icing, and/or snow accumulation on the top surface of vehicles, transport containers, or trailers such as tractor trailers.

In view of the foregoing state of the art, there remains a need in the art for an effective and simple solution to address the problem of ice and snow accumulation that may build up on the top surfaces of vehicles, transport containers, or trailers, tractor trailers or RV trailers.

As such, there remains a need for a simple and effective solution to address the problem of dangerous ice and snow accumulation that may build up on external surfaces of various vehicles, transport containers, and trailers, such as tractor trailers, without the need to use any complicated refrigeration systems or air ducts.

There also remains a need in the art to provide a simple and effective solution to address the problem of dangerous ice and snow accumulation that may build up on external surfaces of various vehicles, transport containers, and trailers, such as tractor trailers, using a battery as a power source.

One or more of the foregoing needs, as well as other needs, addressed by the invention described below.

### SUMMARY OF THE INVENTION

The present invention teaches a self-defrosting cargo transport container comprising, at least one electrically conductive cable, wire or self-heating cable connected to a power source (e.g., a battery) configured to defrost or heat at least one external surface of the cargo transport trailer, transport container, or trailer that may otherwise be susceptible to frost, ice, and/or snow accumulation, and at least one multi-plug electric power connector or nose box configured to accept at least one electrically conductive cable or wire and to distribute electric current throughout at least one electrically conductive cable or wire. If desired, the self-defrosting cargo transport container of the present invention may further include at least one thermostat and at least one temperature sensor to activate or deactivate the cargo transport container defrosting system at a selected temperature above freezing point. The cargo transport container may also be provided with at least one optional ice sensor for activating or deactivating the heating (defrosting) operation, as may be necessary. The at least one electrically conductive cable, wire self-heating cable may be positioned either internally or externally to the container. When positioned internally, the cable or wire may be placed along a the top side of, or affixed to, any support structures that may be present (e.g., the support rails or support beams in a trailer). When positioned externally, the cables or wires may be positioned on an a top side external surface of the transport container, trailer, or vehicle like a recreational vehicle.

In a first exemplary embodiment of the invention, a self-defrosting cargo transport container may comprise: (i) at least one power source; (ii) at least one ON/OFF power switch for activating or deactivating the heating (defrosting) system; (iii) at least one electrically conductive cable or wire configured to dissipate heat onto at least one external surface of the vehicle, transport container, or trailer; and (iv) at least one multi-plug electrical power connector configured to accept the at least one electrically conductive cable or wire and to distribute electric current throughout the at least one electrically conductive cable or wire for heating the conductive cable or wire.

In another exemplary embodiment, a self-defrosting cargo transport container may comprise: (i) at least one power source for providing electrical power in the form of direct current; (ii) a power inverter for receiving the direct current from the power source and converting the direct current to alternating current; (iii) a nose box electrically connected the power inverter for receiving the alternating current from the power inverter and distributing the alternating current; (iv) at least one multi-plug electrical power connector for receiving the distributed alternating current from the nose box and further distributing the alternating current, the multi-plug electrical power connector configured to accept at least one self-heating electrically conductive cable; and (v) at least one self-heating electrically conductive cable electrically connected to the multi-plug electrical power connector, the at least one self-heating electrically conductive cable or wire configured for receiving the alternating current from the multi-plug electrical power connector and to dissipate heat onto at least one external surface of the vehicle, transport container, or trailer.

In another exemplary embodiment, the power source may be a vehicle or tractor (semi-truck) battery.

In another exemplary embodiment, the at least one electrically conductive cable or wire includes a thermally conductive, electrically insulative protective outer layer.

In another exemplary embodiment, the at least one electrically conductive cable or wire is a self-heating heating cable or wire.

In another exemplary embodiment, the self-heating heating cable or wire is operated at a maximum of current of 1 A or maximum power of 120 W.

In another exemplary embodiment, the heating (defrosting) system may be activated or deactivated by a thermostat.

In another exemplary embodiment, the distribution of the alternating current to the self-heating heating cable or the electrical conductive cable may be activated or deactivated based on signals provided by at least one ice detector.

In another exemplary embodiment, the at least one electrically conductive cable or wire is a 16-gauge cable or wire.

In another exemplary embodiment, the battery may be rechargeable.

In another exemplary embodiment, the battery may be recharged by operating an internal combustion engine.

In another exemplary embodiment, the battery may be recharged using solar power.

In another implementation, the at least one power source and the at least one electrically conductive cable or wire is connected via a 7-way electrical power plug-in socket/circuit breaker designed for trailer applications.

In another exemplary embodiment, the elements of the invention may be installed inside a vehicle.

In another exemplar embodiment, the defrosting system may be installed on the external surface of a vehicle.

In another exemplary embodiment, the vehicle may be a van.

In another exemplary embodiment, the vehicle may be a recreational vehicle (RV).

In another exemplary embodiment, the defrosting system described herein may be installed inside a transport container.

In another exemplary embodiment, the heating and defrosting system make be affixed to the support beams of a trailer.

In another exemplary embodiment, trailer is a tractor trailer.

In another exemplary embodiment, the tractor trailer is part of an 18-wheeler tractor trailer.

In another exemplary embodiment, the heating and defrosting system may be installed on a straight truck.

In another exemplary embodiment, the support rails or rails are spaced about 2 to about 3 feet apart from front-to-rear or side-to-side of the vehicle, transport container, or trailer.

In another implementation, the at least one electrically conductive cable or wire of the heating and defrosting system may be installed externally on an outer surface of the vehicle, transport container, or trailer.

In another implementation, the heating (defrosting) system may further include at least one colored light indicator.

In yet another exemplary embodiment, the present invention comprises a self-defrosting cargo trailer including:
a. a top surface, the top surface having a top surface right edge, a top surface left edge, and a top surface front edge, a first lateral support having a first lateral support first end and a first lateral support second end, the first lateral support first end in communication with the top surface right edge, and the first lateral support second end in communication with top surface left edge, a second lateral support having a second lateral support right end and a second lateral support left end, the second lateral support right end in communication with the top surface right edge, and the second lateral support left end in communication with top surface left edge, wherein the first lateral support is laterally spaced from the second lateral support;
b. a right surface, the right surface having a right surface top edge, a right surface bottom edge and a right surface front edge, the right surface top edge in communication with the top surface right edge;
c. a left surface, the left surface having a left surface top edge, a left surface bottom edge and a left surface front edge, the left surface top edge in communication with the top surface left edge;
d. a bottom surface, the bottom surface having a bottom surface right edge, a bottom surface left edge, and a bottom surface front edge, the bottom surface right edge in communication with the right surface bottom edge and the bottom surface left edge in communication with the left surface bottom edge;
e. a front surface, the front surface having a front surface top edge, a front surface bottom edge, a front surface left edge, and a front surface right edge, the front surface top edge in communication with the top surface front edge, the front surface left edge in communication with the left surface front edge, the front surface right edge in communication with the right surface front edge;
f. a power source adjacent to the front surface,
g. a power inverter electrically connected to the power source;
h. a nose box electrically connected to the power inverter;
i. a self-heating heating cable connected to the power inverter, the self-heating heating cable connected to the first lateral report first end, the self-heating heating cable connected to the first lateral support second end, the self-heating heating cable connected to the second lateral support second end, the self-heating heating cable connected to the second lateral support first end.

In still another embodiment, the present invention comprises, A self-defrosting cargo trailer comprising:
a. a top surface, the top surface having a top surface first edge, a top surface second edge, and a top surface front edge, a first lateral support having a first lateral support first end and a first lateral support second end, the first lateral support first end in communication with the top surface first edge, and the first lateral support second end in communication with top surface second edge, a second lateral support having a second lateral support first end and a second lateral support second end, the second lateral support first end in communication with the top surface first edge, and the second lateral support second end in communication with top surface second edge, wherein the first lateral support is laterally spaced from the second lateral support;
b. a right surface, the right surface having a right surface top edge, a right surface bottom edge and a right surface front edge, the right surface top edge in communication with the top surface first edge;
c. a left surface, the left surface having a left surface top edge, a left surface bottom edge and a left surface front edge, the left surface top edge in communication with the top surface second edge;
d. a lower surface, the lower surface having a lower surface first edge, a lower surface second edge, and a lower surface front edge, the lower surface first edge in communication with the right surface bottom edge and the lower surface second edge in communication with the left surface second edge;
e. a front surface, the front surface having a front surface top edge, a front surface bottom edge, a front surface left edge, and a front surface right edge, the front surface top edge in communication with the top surface front edge, the front surface left edge in communication with the left surface front edge, the front surface right edge in communication with the right surface front edge;
f. a power source adjacent to the front surface, the power source generating direct current;
g. a power inverter connected to the power source for receiving the generated direct current and generating alternating current;
h. a noseguard for receiving the generated alternating current and distributing the alternating current;
i. a power switch connected to the power inverter for controlling the distribution of the alternating current generated by the power inverter;
j. an electrically conductive cable connected to the power switch, the electrically conductive cable connected to the first lateral report right end, the electrically conductive cable connected to the first lateral support left end, the electrically conductive cable connected to the second lateral support left end, the electrically conductive cable connected to the second lateral support right end.

Further still, in one embodiment of the present invention, a heating (defrosting) system for a vehicle, transport container, or trailer comprising:
a. at least one power source for generating direct current;
b. at least one ON/OFF power switch electrically connected to the at least one power source for controlling the flow of the generate direct current and, the ON/OFF power switch for activating or deactivating the heating (defrosting) system;
c. at least one multi-plug electrical power connector configured accept the at least one electrically conductive cable or wire and to distribute electric current throughout the at least one electrically conductive cable or wire; and
d. at least one electrically conductive cable or wire in communication with the multi-plug electrical power connector, the electrically conductive cable configured to dissipate heat onto at least one surface of the vehicle, transport container, or trailer when the heating (defrosting) system is activated.

### BRIEF DESCRIPTION OF THE DRAWING FIGURES

The preferred embodiments of the invention will hereinafter be described in conjunction with the appended drawings provided to illustrate and not to limit the invention, where like designations denote like elements, and in which:

FIG. 1 depicts an exemplary tractor trailer for which the present invention may be used.

FIG. 2 depicts the support beams of a tractor trailer for which the invention may be used.

FIG. 3 depicts a partial isometric view of a tractor trailer showing a power source and associated components of a heating (defrosting) system according to the present invention.

FIG. 4 depicts a top view of the tractor trailer equipped with a lighting system in accordance with various embodiments of the present invention.

FIG. 5 depicts a transparent view of the top surface of a tractor trailer equipped with support beams for affixing the electrically conductive cables, wires or self-heating cables, in accordance with another embodiment of the present invention.

FIG. 6 depicts a partial side view of a tractor trailer illustrating the power source electrically connected to the power inverter, and the power invert electrically connected to the nose box, and the nose box electrically connected to a multi-plug electrical connector, and the multi-plug electrical connector electrically connected to trailer lights in accordance with an exemplary embodiment of the present invention.

FIG. 7 depicts an exemplary embodiment of the heating (defrosting) system of the present invention illustrating the electrically conductive cables or wires located front to back with respect to trailer 110.

FIG. 8 depicts an exemplary embodiment of the self-defrosting cargo transport container according to various embodiments of the present invention, wherein self-heating cables ae shown affixed to the top surface support beams of the present invention.

### DETAILED DESCRIPTION OF THE INVENTION

The following detailed description is teaches improvements not found in the prior art. As used herein, the word “exemplary” or “illustrative” means “serving as an example, instance, or illustration.” Any embodiment described herein as “exemplary” or “illustrative” is not necessarily to be construed as preferred or advantageous over other embodiment. All of the embodiments described below are exemplary embodiments provided to enable persons skilled in the art to make or use the embodiments of the disclosure and are not intended to limit the scope of the disclosure, which is defined by the claims.

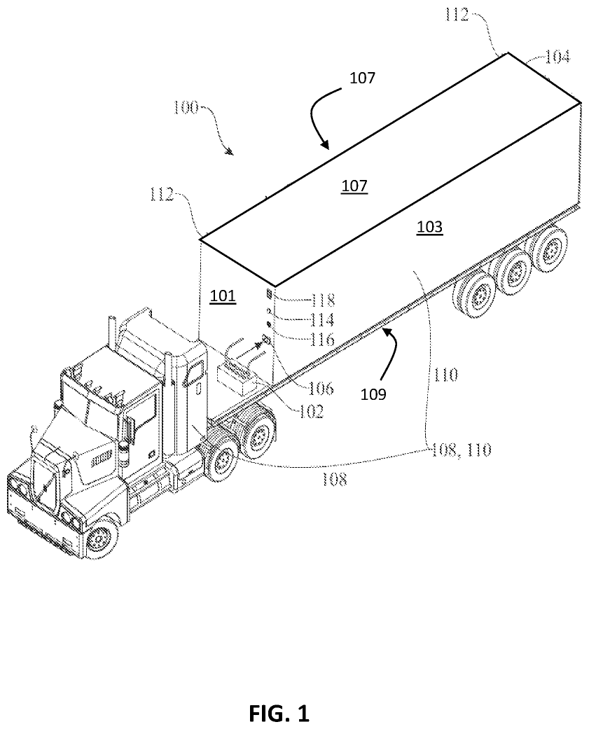

For purposes of description herein, the terms “top”, “bottom”, “upper”, “lower”, “left”, “rear”, “right”, “front”, “vertical”, “horizontal”, “lower” and “upper” and derivatives thereof shall relate to the invention as oriented in FIG. 1. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present invention is directed toward a heating (defrosting) system capable of eliminating, reducing, or preventing frosting, icing, and/or snow accumulation on the top surface of various vehicles (such as trucks, vans, or recreational vehicles (RVs)), transport containers, or trailers (such as tractor trailers or RV trailers). The present invention is further directed to a self-defrosting cargo transport container capable of eliminating, reducing, or preventing frosting, icing, and/or snow accumulation on the cargo transport container top surface.

Referring now to FIG. 1, an exemplary environment 100 for use with the present invention is depicted. As shown, a semi-tractor 108 may be connected to a cargo trailer 110. Trailer 110 may be any trailer for transporting cargo therein. Trailer 110 may include a planar front surface 101 physically connected to a planar right surface 103 on a front surface right edge. Front surface 101 may be physically connected to a planar left surface 105 on a front surface left edge. Trailer 110 may further include a top surface 107 physically connected to front surface 101 on a front surface top edge. Trailer 110 may further include a bottom surface 109 physically connected to the front surface 101 front surface bottom edge. Front surface 101, right surface 103, left surface 105, top surface 107 and bottom surface 109 may be configured such that, the front surface 101, right surface 103, left surface 105, top surface 107 and bottom surface 109 form a hollow container in which cargo may be transported. In one exemplary embodiment right surface 103, left surface 105, top surface 107 and bottom surface 109 may be elongated. In another exemplary embodiment right surface 103, left surface 105, top surface 107 and bottom surface 109 may be contiguous in that they form a single cargo transport hull.

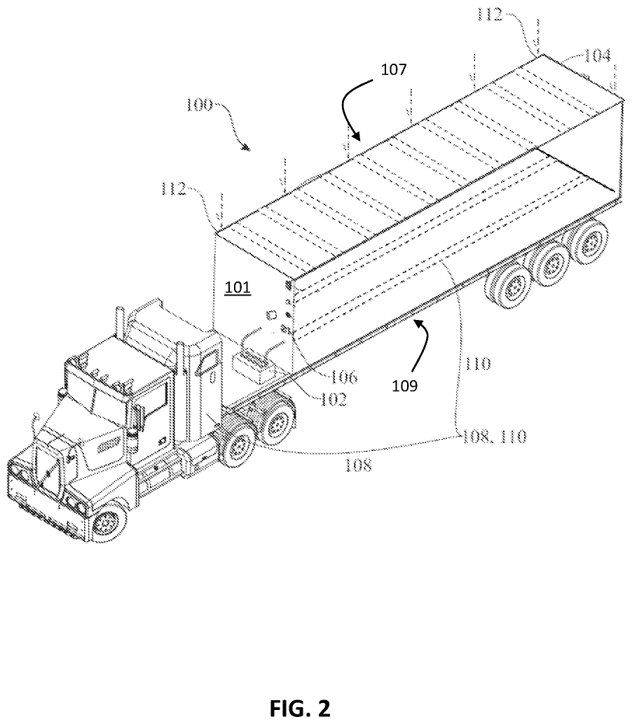

With reference to FIG. 2, a transparent view of cargo transport trailer 110 is depicted. Transport trailer 110 may include support beams 111 for support beams 111 supporting weight of top surface 108. Top surface trailer support beams 111 may be positioned to extend from right surface 103 to left surface 105. Top surface trailer support beams 111 may be positioned to within the cargo trailer 110 to support the weight of top surface 107. In one exemplary embodiment, trailer support beams 111 may be laterally separated one from another by a predetermined distance. In another embodiment, top surface trailer support beams 111 may be perpendicular to right surface 103 and perpendicular to left surface 105.

FIG. 2 further depicts further depicts bottom surface trailer support beams 113 for supporting bottom surface 109. Bottom surface trailer support beams 113 may be longitudinal and be positioned parallel to right surface 103 and parallel to left surface 105. In one exemplary embodiment, bottom surface trailer support beams may be located external to bottom surface 109.

Although top surface trailer support beams 111 are described herein as being perpendicular to right surface 103 and perpendicular to left surface 105, other arrangements of the top surface trailer support beams are considered within the scope of the invention. That is, the top surface support beams 111 may crisscross from the front surface 101 along the underside of top surface 107. Indeed, it should be noted that conventional trailer constructions, while not described herein, are well known, and will not be described for brevity. Such well known alternate configuration of cargo trailers are within the scope of the present invention.

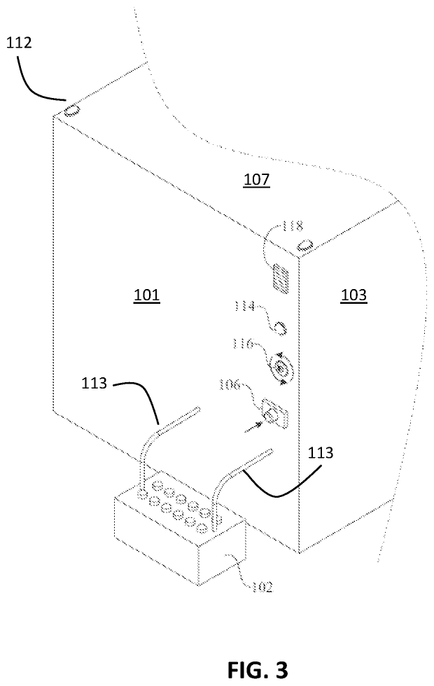

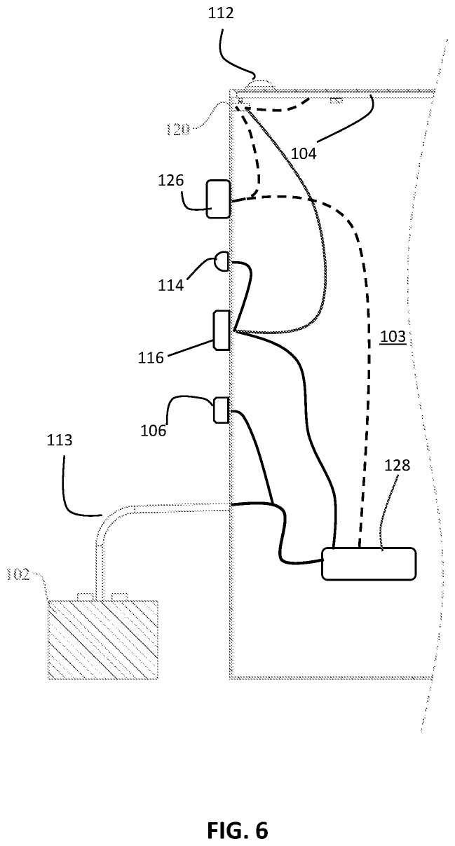

Referring now to FIGS. 3 through 7, what is shown are operational components of the heating (defrosting) system according to the present invention. As shown in FIGS. 3 and 6, a power source (battery) 102, may be electrically connected to power inverter 124 for providing direct current to power inverter 124. In one embodiment, power inverter 124 may be electrically connected to an ON/OFF power switch 106 configured to control the flow of alternating current from power inverter 124.

In another exemplar embodiment, power inverter 124 may be electrically connected to a thermostat 116 for regulating the alternating current distributed from power inverter 124. Thermostat 116 may further be connected to a multi-plug electrical power connector 120 configured to allow devices to be plugged therein to receive the alternating current distributed by power inverter 124. The multi-plug power connector 120 may be a 7-way, 20 amp power plug-in socket connector/circuit breaker commonly used for trailer applications to provide power to the trailer. Again, the marker lights 112 may also be connected to the 7-way 20 amp power plug-in socket connector/circuit breaker, if desired.

As described more fully below, power inverter 124 may be connected to a conventional nose box 126, wherein the nose box may be further electrically connected to ON/OFF power switch 106, thermostat 116 and multi-plug electrical power connector 120 for distributing alternating current to those elements. The construction of, and operation of nose boxes used on tractor trailers is well known. As such, the nose box of the present invention will not be discussed herein for brevity.

A typical power inverter 124 that may be used with the present invention is the Trailer Auxiliary Power System (TAPS) produced by Purkeys. The TAPS is designed to provide auxiliary AC power at 120 volts—in a trailer so that devices needing AC power may be powered while on a trailer. In the present invention, the TAPS provides AC power to charge devices while truck 108 is moving between stops. The TAPS power inverter 124 is configured to keep devices (i.e., nose box 126) at a high state of charge during operation of the trailer 110 is in operation.

Power inverter 124 may receive direct current from the tractor 108 via the dual pole power cord 113. If mounted on a straight truck, the power inverter 124 receives DC current from tractor 108 batteries 102. In one exemplary embodiment, once the power inverter 124 receives the DC current, the power inverter 124 may stay on until the DC current drops below a voltage threshold. For example, once the DC voltage dops below 12.4 Volts for 30 seconds and will not turn back on until the power inverter 124 experiences a DC input of 13.2 volts.

In one exemplary embodiment, power inverter 124 is powered via one or more electrically conductive cables or wires 113 for receiving direct current from power source 102. ON/OFF power switch 106, and a multi-plug electrical power connector 120 configured to accept the one or more electrically conductive cables or wires 104 and to distribute electric current throughout the one or more electrically conductive cables or wires 104. In this embodiment, the power source 102 for the heating (defrosting) is a battery 102 that may be separate from the semi-truck 108's main battery (not shown). It is possible, however, that the power source 102 and the semi-truck 108's main battery could be one and the same, depending on the battery capacity and the load on the tractor trailer (108, 110). Power source 102, which may be in the form of a battery, may be charged by an alternator/generator (not shown) running from an internal combustion engine (not shown). It is also possible to charge the power source 102 in the form of a battery with a solar power system (not shown), as is prevalent in many types of equipment or systems used in mobile transport systems.

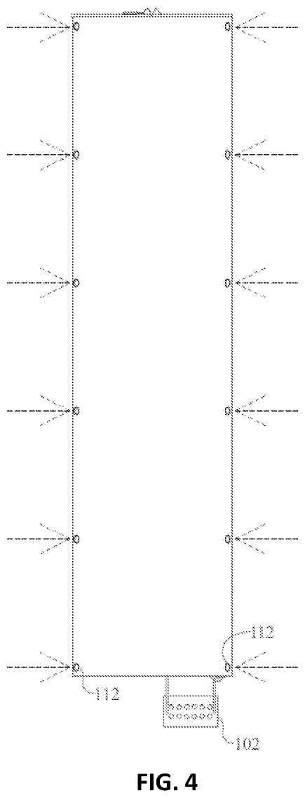

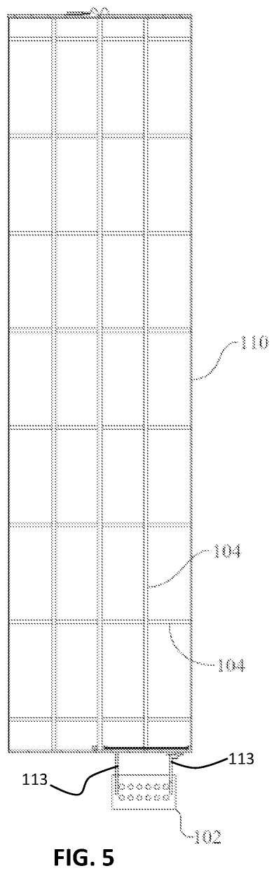

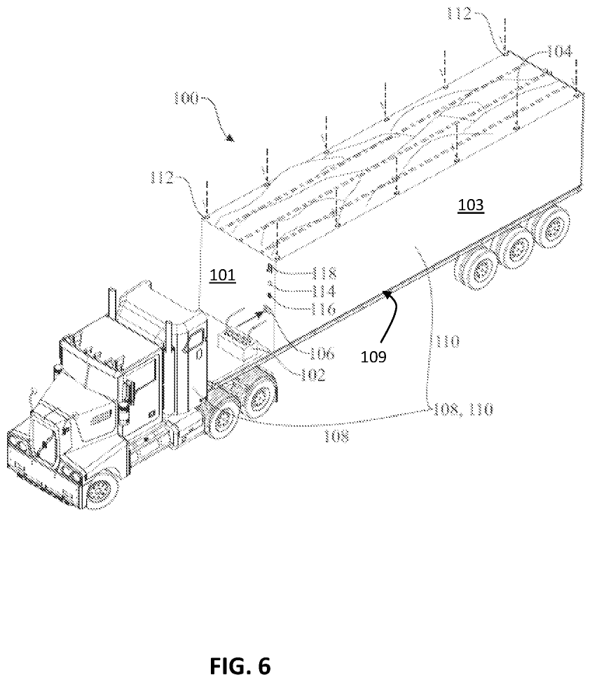

As shown in FIG. 5, the one or more electrically conductive cables or wires 104 may be connected to multi-plug power connector 120 and installed externally on top of the trailer 110, along with multiple marker lights 112 (shown in FIG. 4 and FIG. 7), which may or may not be part of the same electrical circuit as the heating (defrosting) system 100, to form an arrangement or network of one or more electrically conductive cables or wires 104 on top of the trailer 100's surface. In this regard, it should be noted that about 80% of trailers are made from aluminum or fiber glass.

In the embodiment in which the one or more electrically conductive cables or wires 104 are disposed externally on the top surface of trailer 110, the one or more electrically conductive cables or wires 104 may be arranged in the direction of the length of the trailer 110 (i.e., front to back shown in FIG. 7), or in the direction of the width of the trailer 110 (i.e., from side-to-side), as shown in FIG. 5. FIG. 5 shows the one or more electrically conductive cables or wires 104 in both directions, but it is possible to install the one or more electrically conductive cables or wires 104 in only one direction (i.e., either lengthwise or widthwise). Additionally, it is possible to have the one or more electrically conductive cables or wires 104 arranged in other configurations, such as spaced-apart one or more electrically conductive cables or wires 104 oriented in the width direction but adjacent cable or wire segments being joined at alternating ends by additional cable or wire 104 segments oriented in the length direction along the long edges of the trailer to form a roughly repeating “S” or “5” configuration.

The one or more electrically conductive cables or wires 104 may be spaced apart by any suitable distance that would be appropriate to provide sufficient heat to the top surface 107 of the trailer 110 such that the frost, ice, and/or snow would be prevented from forming or, if already formed, melted efficiently. For example, the one or more electrically conductive cables or wires 104 may be spaced apart at distances of about 2 to about 3 feet, but smaller or larger distances are also possible.

The thicknesses of the one or more electrically conductive cables or wires 104 are also not particularly limited. It has been found, however, that 16-gauge wire is suitable for effective and efficient performance of the heating (defrosting) system 100. An electrically insulative but thermally conductive layer may be provided as an outer protective layer on the one or more electrically conductive cables or wires 104, if desired.

The heating (defrosting) system 100 may be powered on by activating the power switch 106, which is an ON/OFF switch and may be accessible either externally and/or internally, such that electrical current may be dissipated into heat energy, by the one or more electrically conductive cable or wire 104's inherent electrical resistance. As best illustrated in FIG. 1, the heating (defrosting) system 100 may further include a light indicator 114 (e.g., amber colored light) electrically connected to the ON/OFF switch to show whether the heating (defrosting) system 100 is in the active or inactive state. By active state, what is meant is that generated alternating current is being supplied to one of the nose box 122, or multi-plug electrical connector 120.

The heating (defrosting) system 100 may also be provided with a thermostat 116, as shown in FIGS. 3 and 6, that works in combination with one or more temperature sensors (not shown) placed at selected locations on the surface of the trailer being heated or defrosted. For example, the thermostat 116 may be set at any temperature above freezing but no more than about 40° F. to reduce the possibility of energy waste.

Additionally, the one or more electrically conductive cables or wire 104 may desirably be of the self-heating type. In such an embodiment, the one or more electrically conductive cables or wires 104 may be self-limiting to a maximum power level of, e.g., 120 watts, or a maximum current of, e.g., 1 ampere. In this way, wasted energy can be minimized.

Furthermore, it is possible to install an ice detector or sensor 118, as shown in FIG. 3, in lieu of or in addition to other features, such as the thermostat 116, described above. Although FIG. 3 shows the ice detector or sensor 118 on the front surface of the trailer 110, it should be understood that it can be placed at any suitable location near the surface being heated, including at the top surface 107 of the trailer 110. Ice detector sensor 118 may be any conventional ice detector sensor as if found on the prior art. In operation, an electric current from power inverter 124 connected to ice detector sensor 118 induces the ice detector sensor 118 to resonate (vibrate) at a specific ultrasonic frequency. Ice accumulation on the probe causes the resonance frequency to decrease. Detector logic of the ice detector sensor 118 senses the change in frequency and triggers a the electrically conductive cables or wires 104 to activate.

By implementing the one or more electrically conductive cables or wires 104, the thermostat 116, and/or one or more ice detectors/sensors 118, the heating (defrosting) system can be operated automatically with improved energy savings. Alternatively, when these features are omitted or unavailable due to servicing or the like, the heating (defrosting) system can be operated successfully in manual mode simply turning the heating (defrosting) system either ON or OFF by activating or deactivating the ON/OFF power switch 106.

As mentioned previously, the one or more electrically conductive cables or wires 104 may be installed inside the trailer 110, as shown in, for example, FIG. 5, rather than externally. Internal installation of the one or more electrically conductive cables or wires 104 is preferred over external installation. When installed internally, the one or more electrically conductive cables or wires 104 may be disposed along any support rails 113 that may be present in the trailer 110.

It is within the scope of the present invention to not only provide the one or more electrically conductive cables or wires 104 on the surface(s) of the trailer, but also the semi-truck itself, including the top of the truck 108, if desired.

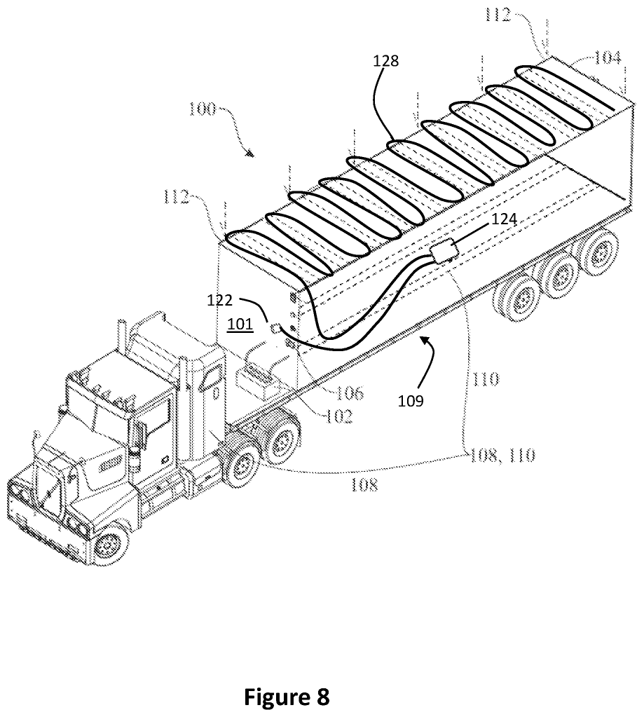

In another exemplary embodiment of the present invention show in FIG. 8, one or more self-heating heating cables or wires 128 may be connected to nose box 122. Nose box 122 may be further connected to power inverter 124. As shown, power inverter 124 may be located underneath trailer bottom surface 109. Preferably, power inverter 124 may be place before the tandem wheels 130 at the rear of the trailer 110. Preferably, power inverter 124 may be positioned underneath trailer bottom surface 109 before trailer 110 landing gear (not shown). When a nose box 122 is not used, Power inverter 124 may be connected directly to the multi-plug electrical power connector 120. In an alternate embodiment, power invertor 124 may be connected to nose box 126. In this embodiment, nose box 122 may be further connected directly to self-heating heating cables or wires 128 for providing alternating current to activate self-heating heating cables 128.

Self-regulating heating cables 128 may be any conventional self-heating heating cables 128 as is known in the art. As is well known, self-heating heating cables 128 are used to efficiently and safely apply heat for safety, process maintenance, comfort and more. Self-regulating heating cables work by being attached directly to the area that requires heating. For example, self-heating heating cables 128 may be affixed to the external surface of trailer top surface 107 in similar manner as was discussed with electrically conductive cables or wires 104. In another exemplary embodiment, self-heating heating cables 128 may be affixed internally to the trailer top surface 107. For example, self-heating heating cables 128 may be affixed to top surface trailer support beams 111. As shown in FIG. 2, top surface trailer support beams 111 may be positioned perpendicular to right surface 103 and left surface 105. Self-regulating heating cables 128 may be attached to a plurality of top surface trailer support beams 111 to ensure that the entire top surface 107 is heated during operation.

When self-heating heating cables 128 receive alternating current either directly or indirectly from power inverter 124, such as via nose box 122 or multi-plug electrical connector 120 or nose box 126 as described above with respect to electrically conductive cables or wires 104, the conductive core do the self-heating heating cables produce heat to defrost top surface 107. Specifically, as the ambient temperature above top surface 107 drops, such as when covered by ice or snow, the conductive core of the self-heating heating cable 128 contracts microscopically, increasing the conductivity of the self-heating heating cable 128 and increasing the self-heating cable heat output. As the ambient temperature increased, the conductivity of the self-heating heating cable 128 conductive core expands microscopically, reducing the core's conductivity and reducing the self-heating cable 128 heat output.

Although the present invention describes a heating (defrosting) system for a tractor trailer (108, 110), it should be understood that the concepts of the present invention can be applied to other applications (e.g., cargo vans, RVs, and RV trailers).

Since many modifications, variations, and changes m detail can be made to the described preferred embodiments of the invention, it is intended that all matters in the foregoing description and shown in the accompanying drawings be interpreted as illustrative and not in a limiting sense. Thus, the scope of the invention should be determined by the appended claim(s) and their legal equivalents.

What is claimed is:

1. A self-defrosting cargo trailer comprising:
a. a top surface, the top surface having a top surface right edge, a top surface left edge, and a top surface front edge, a first lateral support having a first lateral support first end and a first lateral support second end, the first lateral support first end in communication with the top surface right edge, and the first lateral support second end in communication with top surface left edge, a second lateral support having a second lateral support right end and a second lateral support left end, the second lateral support right end in communication with the top surface right edge, and the second lateral support left end in communication with top surface left edge, wherein the first lateral support is laterally spaced from the second lateral support;
b. a right surface, the right surface having a right surface top edge, a right surface bottom edge and a right surface front edge, the right surface top edge in communication with the top surface right edge;
c. a left surface, the left surface having a left surface top edge, a left surface bottom edge and a left surface front edge, the left surface top edge in communication with the top surface left edge;
d. a bottom surface, the bottom surface having a bottom surface right edge, a bottom surface left edge, and a bottom surface front edge, the bottom surface right edge in communication with the right surface bottom edge and the bottom surface left edge in communication with the left surface bottom edge;
e. a front surface, the front surface having a front surface top edge, a front surface bottom edge, a front surface left edge, and a front surface right edge, the front surface top edge in communication with the top surface front edge, the front surface left edge in communication with the left surface front edge, the front surface right edge in communication with the right surface front edge;
f. a power source adjacent to the front surface,
g. a power inverter electrically connected to the power source;
h. a nose box electrically connected to the power inverter;
i. a self-heating cable connected to the power inverter, the self-heating heating cable connected to the first lateral report first end, the self-heating heating cable connected to the first lateral support second end, the self-heating heating cable connected to the second lateral support second end, the self-heating heating cable connected to the second lateral support first end.

2. A self-defrosting cargo trailer of claim 1, wherein the power source is a semi-truck battery.

3. A self-defrosting cargo trailer of claim 2, wherein the semi-truck batter is rechargeable.

4. A self-defrosting cargo trailer of claim 1, wherein the power source is a straight line truck.

5. A self-defrosting cargo trailer of claim 1, further including an ice detector, the ice detector electrically connected to the self-heating cable.

6. A self-defrosting cargo trailer of claim 1, wherein the self-heating cables are installed underneath of top surface.

7. A self-defrosting cargo trailer of claim 1, wherein the self-heating cables are installed above the top-surface.

8. A self-defrosting cargo trailer comprising:
a. a top surface, the top surface having a top surface first edge, a top surface second edge, and a top surface front edge, a first lateral support having a first lateral support first end and a first lateral support second end, the first lateral support first end in communication with the top surface first edge, and the first lateral support second end in communication with top surface second edge, a second lateral support having a second lateral support first end and a second lateral support second end, the second lateral support first end in communication with the top surface first edge, and the second lateral support second end in communication with top surface second edge, wherein the first lateral support is laterally spaced from the second lateral support;
b. a right surface, the right surface having a right surface top edge, a right surface bottom edge and a right surface front edge, the right surface top edge in communication with the top surface first edge;
c. a left surface, the left surface having a left surface top edge, a left surface bottom edge and a left surface front edge, the left surface top edge in communication with the top surface second edge;
d. a lower surface, the lower surface having a lower surface first edge, a lower surface second edge, and a lower surface front edge, the lower surface first edge in communication with the right surface bottom edge and the lower surface second edge in communication with the left surface second edge;
e. a front surface, the front surface having a front surface top edge, a front surface bottom edge, a front surface left edge, and a front surface right edge, the front surface top edge in communication with the top surface front edge, the front surface left edge in communication with the left surface front edge, the front surface right edge in communication with the right surface front edge;
f. a power source adjacent to the front surface, the power source generating direct current;
g. a power inverter connected to the power source for receiving the generated direct current and generating alternating current;
h. a noseguard for receiving the generated alternating current and distributing the alternating current;
i. a power switch connected to the power inverter for controlling the distribution of the alternating current generated by the power inverter;
an electrically conductive cable connected to the power switch, the electrically conductive cable connected to the first lateral report right end, the electrically conductive cable connected to the first lateral support left end, the electrically conductive cable connected to the second lateral support left end, the electrically conductive cable connected to the second lateral support right end.

9. A self-defrosting cargo trailer of claim 8, wherein the power source is a semi-truck battery.

10. A self-defrosting cargo trailer of claim 9, wherein the semi-truck batter is rechargeable.

11. A self-defrosting cargo trailer of claim 8, wherein the power source is a straight line truck.

12. A self-defrosting cargo trailer of claim 8, further including an ice detector, the ice detector electrically connected to the self-heating cable.

13. A self-defrosting cargo trailer of claim 8, wherein the self-heating cables are installed underneath of top surface.

14. A self-defrosting cargo trailer of claim 1, wherein the self-heating cables are installed above the top-surface.

15. A heating (defrosting) system for a transport container comprising:
a. A power source for producing direct current;
b. a power inverter electrically connected to the power source, the power inverter for converting the direct current to alternating current, the power inverter for disseminating the alternating current;
c. an ON/OFF power switch in electrical communication with the power source for controlling the distribution of the alternating current;
d. at multi-plug electrical power connector in electrical communication with the ON/OF power switch for receiving the controlled distributed alternating current, the multi-plug electrical power connector configured to further distribute the controlled distributed alternating current;
e. at least one electrically conductive cable electrically connected to the multi-plug electrical power connector for receiving the further distributed controlled alternating current, the electrically conductive cable configured to dissipate heat.

16. A heating (defrosting) system for a transport container according to claim 15, wherein the at least one electrically conductive cable dissipated heat on an external surface of a vehicle.

17. A heating (defrosting system for a transport container according to claim 15, wherein the at least one electrically conductive cable dissipated heat on an internal surface of a vehicle.

18. A heating (defrosting system for a transport container according to claim 15, wherein the vehicle is a RV.

19. A heating (defrosting system for a transport container according to claim 15, wherein the transport container is a trailer for use with a semi-truck.

20. A heating (defrosting system for a transport container according to claim 15, wherein the vehicle is a straight truck.
